(19) United States
(12) Patent Application Publication
(10) Pub. No.: US 2025/0315158 A1
(43) Pub. Date: Oct. 9, 2025

(54) METHOD, APPARATUS, COMPUTER DEVICE AND STORAGE MEDIUM FOR INFORMATION DISPLAY

(71) Applicant: Beijing Zitiao Network Technology Co., Ltd., Beijing (CN)

(72) Inventor: Heng ZHANG, Singapore (SG)

(21) Appl. No.: 18/860,894

(22) PCT Filed: Aug. 21, 2023
(86) PCT No.: PCT/CN2023/114130

§ 371 Date: Oct. 28, 2024

(30) Foreign Application Priority Data
Oct. 31, 2022 (CN) 202211346964.2

(51) Int. Cl. G06F 3/0485; G06F 3/0488

(52) U.S. Cl. CPC G06F 3/0485; G06F 3/0488

(57) ABSTRACT

The disclosure provides a method, apparatus, computer device and a storage medium for information display. The method includes: determining a current display state of a top information area displayed on a target page; in response to sliding on the target page, determining a target state of the top information area based on the sliding and the current display state; and updating to display a changed effect of the top information area under the sliding, to cause the top information area to change from the current display state to the target state, and displaying a detail information area on the target page based on the changed effect; the detail information area being associated with a display location of the top information area on the target page.

The present application claims priority to Chinese Patent Application No. CN202211346964.2, filed on Oct. 31, 2022, and entitled “METHOD, APPARATUS, COMPUTER DEVICE, AND STORAGE MEDIUM FOR INFORMATION DISPLAY”, the entirety of which is incorporated herein by reference.

### FIELD

The present disclosure relates to the technical field of computers, in particular to a method, an apparatus, a computer device, and a storage medium for information display for information display.

### BACKGROUND

When information is displayed to a user through a page, in order to distinguish and display different information, a top information area can be divided from the page, and promotion information such as activities and special subjects is displayed in the top information area to attract the attention of the user. Detailed information including specific content and the like is displayed below the top information area. In order to reduce the occupation of the page by the top information area when the user browses the detailed information, the top information area may be selected to be displayed or turned off, but when the top information area is currently operated, the form change of the top information area is not smooth, resulting in poor user experience.

### SUMMARY

Embodiments of the present disclosure at least provide a method, an apparatus, a computer device, and a storage medium for information display for information display.

In a first aspect, embodiments of the present disclosure provide a method for information display, comprising: determining a current display state of a top information area displayed on a target page; in response to sliding on the target page, determining a target state of the top information area based on the sliding and the current display state; and updating to display a changed effect of the top information area under the sliding, to cause the top information area to change from the current display state to the target state, and displaying a detail information area on the target page based on the changed effect; the detail information area being associated with a display location of the top information area on the target page.

In an optional implementation, the current display state comprises a contracted state or an expanded state; and determining the target state of the top information area based on the sliding and the current display state comprises: in response to the current display state being the contracted state and the sliding being indicative of expanding the top information area, or in response to the current display state being the expanded state and the sliding being indicative of contracting the top information area, determining a sliding parameter corresponding to the sliding to determine the target state of the top information area using the sliding parameter.

In an optional implementation, the sliding parameter comprises at least one of a sliding distance or a sliding speed; determining the target state of the top information area based on the sliding parameter comprises: in response to the sliding speed in the sliding parameter being greater than a predetermined threshold, determining that the target state is the contracted state or the expanded state different from the current display state; and in response to the sliding speed in the sliding parameter being less than the predetermined threshold, determining whether the sliding is indicative of crossing a predetermined decision line based on the sliding distance in the sliding parameter, and determining the target state based on a determining result; wherein a location of the predetermined decision line on the target page is determined based on a boundary location of the top information area in the contracted state or the expanded state.

In an optional implementation, determining whether the sliding is indicative of crossing the predetermined decision line based on the sliding distance in the sliding parameter comprises: determining a sliding variation distance of the boundary location of the top information area by using the sliding distance; determining whether the sliding variation distance is greater than a separation distance between the boundary location of the top information area in the current display state and a boundary location of the predetermined decision line; in response to the sliding variation distance being less than the separation distance, determining that the sliding is indicative of non-crossing the predetermined decision line, otherwise, determining that the sliding is indicative of crossing the predetermined decision line.

In an optional implementation, determining the target state based on the determining result comprises: in response to the determining result being that the sliding is indicative of non-crossing the predetermined decision line, determining that the target state is the current display state; or in response to the determining result being that the sliding is indicative of non-crossing the predetermined decision line, determining that the target state is the contracted state or the expanded state different from the current display state.

In an optional implementation, the current display state comprises an initial state; and determining the target state of the top information area based on the sliding and the current display state comprises: in response to the sliding being indicative of displaying the top information area, determining that the target state of the top information area is an expanded state; or in response to the sliding being indicative of contracting the top information area, determining that the target state of the top information area is a contracted state.

In an optional implementation, the method further includes: in response to the current display state of the top information area being a contracted state, and the sliding being indicative of displaying the detail information area, updating the displaying of the detail information area based on a sliding parameter corresponding to the sliding.

In a second aspect, embodiments of the present disclosure further provide an apparatus for information display, comprising: a first determining module configured to determine a current display state of a top information area displayed on a target page; a second determining module configured to, in response to sliding on the target page, determine a target state of the top information area based on the sliding and the current display state; and a display module configured to update to display a changed effect of the top information area under the sliding, to cause the top information area to change from the current display state to the target state, and displaying a detail information area on the target page based on the changed effect; the detail information area being associated with a display location of the top information area on the target page.

In an optional implementation, the current display state comprises a contracted state or an expanded state, and when determining the target state of the top information area based on the sliding and the current display state, the second determining module is configured to: in response to the current display state being the contracted state and the sliding being indicative of expanding the top information area, or in response to the current display state being the expanded state and the sliding being indicative of contracting the top information area, determine a sliding parameter corresponding to the sliding to determine the target state of the top information area using the sliding parameter.

In an optional implementation, the sliding parameter comprises at least one of a sliding distance or a sliding speed; when determining the target state of the top information area based on the sliding parameter, the second determining module is configured to: in response to the sliding speed in the sliding parameter being greater than a predetermined threshold, determine that the target state is the contracted state or the expanded state different from the current display state; and in response to the sliding speed in the sliding parameter being less than the predetermined threshold, determine whether the sliding is indicative of crossing a predetermined decision line based on the sliding distance in the sliding parameter, and determine the target state based on a determining result; wherein a location of the predetermined decision line on the target page is determined based on a boundary location of the top information area in the contracted state or the expanded state.

In an optional implementation, when determining whether the sliding is indicative of crossing the predetermined decision line based on the sliding distance in the sliding parameter, the second determining module is configured to: determine a sliding variation distance of the boundary location of the top information area by using the sliding distance; determine whether the sliding variation distance is greater than a separation distance between the boundary location of the top information area in the current display state and a boundary location of the predetermined decision line; and in response to the sliding variation distance being less than the separation distance, determine that the sliding is indicative of non-crossing the predetermined decision line, otherwise, determining that the sliding is indicative of crossing the predetermined decision line.

In an optional implementation, when determining the target state based on the determining result, the second determining module is configured to: in response to the determining result being that the sliding is indicative of non-crossing the predetermined decision line, determine that the target state is the current display state; or in response to the determining result being that the sliding is indicative of non-crossing the predetermined decision line, determine that the target state is the contracted state or the expanded state different from the current display state.

In an optional implementation, the current display state comprises an initial state; when determining the target state of the top information area based on the sliding and the current display state, the second determining module is configured to: in response to the sliding being indicative of displaying the top information area, determine that the target state of the top information area is an expanded state; or in response to the sliding being indicative of contracting the top information area, determine that the target state of the top information area is a contracted state.

In an optional implementation, the display module is further configured to: in response to the current display state of the top information area being a contracted state, and the sliding being indicative of displaying the detail information area, update the displaying of the detail information area based on a sliding parameter corresponding to the sliding.

In a third aspect, an optional implementation of the present disclosure further provides a computer device, comprising a processor, and a memory, where the memory stores machine-readable instructions executable by the processor, the processor is configured to execute machine-readable instructions stored in the memory, and the processor, when the machine-readable instructions are executed by the processor, performs the steps in any of the first aspect or the possible implementations of the first aspect.

In a fourth aspect, an optional implementation of the present disclosure further provides a computer-readable storage medium, where the computer-readable storage medium stores a computer program, and when the computer program is run, the steps in the first aspect or any possible implementation of the first aspect are performed.

According to the method, apparatus, computer device and the storage medium for information display provided by embodiments of the present disclosure, the target state for displaying the top information area may be determined, according to the sliding operation, on the target page displaying the top information area, and the changed effect of the top information area from the current display state to the target state is updated to display, so that the top information area may follow the user's operation, providing a smooth display with process changes in form, and also improving the user's experience of the page during operation.

In order to make the above objects, features and advantages of the present disclosure more comprehensible, the following detailed description is given below with reference to the accompanying drawings.

### BRIEF DESCRIPTION OF DRAWINGS

In order to more clearly illustrate the technical solutions of the embodiments of the present disclosure, the accompanying drawings, which need to be used in the embodiments, are briefly introduced below, and the drawings herein are incorporated into the specification and constitute a part of the present specification, and these drawings illustrate embodiments consistent with the present disclosure, and are used together with the specification to explain the technical solutions of the present disclosure. It should be understood that the following drawings illustrate only certain embodiments of the present disclosure, and therefore should not be regarded as limiting the scope, and for those skilled in the art, other related drawings may also be obtained according to these drawings without creative work.

FIG. 1 illustrates a flowchart of a method for information display according to embodiments of the present disclosure;

FIG. 2 illustrates a schematic diagram of a target page according to embodiments of the present disclosure;

FIG. 3 illustrates a schematic diagram of a top information area under different display states according to embodiments of the present disclosure;

FIG. 4 illustrates a schematic diagram of a predetermined decision line according to embodiments of the present disclosure;

FIG. 5 illustrates a schematic diagram of changing a top information area to an expanded state according to an embodiment of the present disclosure;

FIG. 6 illustrates a schematic diagram of an apparatus for information display according to embodiments of the present disclosure; and

FIG. 7 illustrates a schematic diagram of a computer device according to embodiments of the present disclosure.

### DETAILED DESCRIPTION

In order to make the objectives, technical solutions and advantages of the embodiments of the present disclosure clearer, the technical solutions in the embodiments of the present disclosure will be clearly and completely described below with reference to the accompanying drawings in the embodiments of the present disclosure. Apparently, the described embodiments are only a part of the disclosed embodiments, not all of them. Components of the disclosed embodiments generally described and illustrated herein may be arranged and designed in a variety of different configurations. Therefore, the following detailed description of embodiments of the present disclosure is not intended to limit the scope of the claimed disclosure, but merely represents selected embodiments of the present disclosure. All other embodiments obtained by those skilled in the art without creative efforts shall fall within the scope of the present disclosure.

Through research, it has been found that in a page displaying information to a user, a top information area separately displaying information may be included, and the top information area may be displayed or closed according to an operation of the user. In a specific operation, the top information area may be directly opened and displayed, or closed and hidden in response to the operation of the user. In fact, the top information area occupies a certain area of the page, and the change of the form may cause the top information area to suddenly show or disappear instantaneously in the page, and the change of the form is not smooth, resulting in poor user experience on the page during operation.

Based on the above research, the present disclosure provides a method for information display. With this method, a target state for displaying the top information area may be determined, according to a sliding operation, on a target page displaying the top information area. Further, a changed effect of the top information area from the current display state to the target state is updated to display, so that the top information area may follow the operation of the user, and thus a smooth display with process change in the form is provided, and the user experience on the page is also improved during operation.

The defects existing in the above solutions are all the results obtained by the inventor after being practiced and carefully studied. Therefore, the process of discovering the above issues and the solution proposed by the present disclosure for the above issues should be the contributions made by the inventor to the present disclosure in the process of the present disclosure.

It should be noted that similar numerals and letters refer to similar items in the following drawings, and therefore, once a certain item is defined in one drawing, it is not required to further define and explain in subsequent drawings.

To facilitate understanding of this embodiment, the method for information display disclosed in the embodiments of the present disclosure is described in detail firstly. An execution body of the method for information display provided in the embodiments of the present disclosure is generally a computer device having a certain computing capability, and the computer device includes, for example, a terminal device, a server or another processing device. The terminal device may be a user equipment (UE), a mobile device, a user terminal, a terminal, a cellular phone, a cordless phone, a personal digital assistant (PDA), a handheld device, a computing device, a vehicle-mounted device, a wearable device, and the like. In some possible implementations, the method for information display may be implemented by a processor invoking a computer readable instruction stored in a memory.

The following describes the method for information display provided in the embodiments of the present disclosure by taking the execution body as a server as an example. The method for information display provided by embodiments of the present disclosure may be applied to interface display of an application software and interface display of a webpage. Generally, the top information area may be used to display product information, activity promotion information, and the like. By utilizing a reading habit of the user from top to bottom, key information is highlighted to the user to attract attention of the user. In the displayed page, the top information area usually occupies only a part of the area above the page, and does not completely occupy the page, which may refer to the specific description hereinafter. In this embodiment of the present disclosure, the area is referred to as a detail information area.

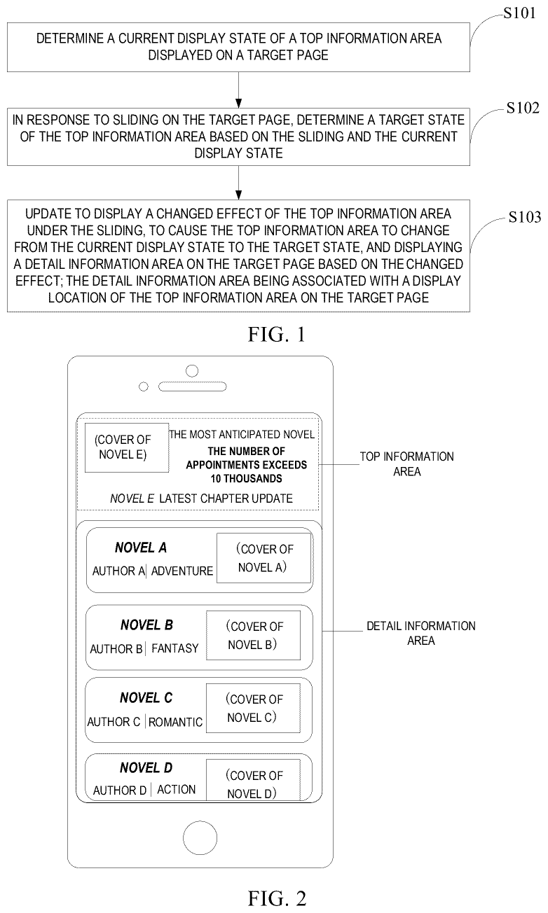

Reference is made to FIG. 1, which is a flowchart of a method for information display according to embodiments of the present disclosure.

At S101: a current display state of a top information area displayed on a target page is determined.

At S102: in response to sliding on the target page, a target state of the top information area is determined based on the sliding and the current display state.

At S103: a changed effect of the top information area under the sliding is updated to display, to cause the top information area to change from the current display state to the target state, and a detail information area on the target page is displayed based on the changed effect; the detail information area being associated with a display location of the top information area on the target page.

S101 to S103 are described in detail below.

For the foregoing S101, the target page is first described. According to the above description, the target page may be a display page in an application, or may be a display page in a webpage. The following takes the target page as the display page in the application for description. In the target page, the target page may specifically include the top information area and the detail information area. The information specifically carried in the top information area and the detail information area may be associated, for example, in a shopping software, the top information area describes the currently ongoing discount activity, and a product under the discount activity may be displayed in the detail information area. The information specifically carried in the top information area and the detail information area may also be not associated, for example, in a search page, the top information area introduces current hot search news, and in the detail information area, the search result displayed to the user according to the search problem posed by the user is specifically described. Since information display approaches specifically described in the embodiments of the present disclosure are related to actual operation of the user, the information carried in the top information area and the detail information area is not limited herein.

In an example, reference is made to FIG. 2, which is a schematic diagram of a target page according to embodiments of the present disclosure. The target page in the example is a page for displaying a plurality of novels in a novel reading application, where the top information area includes promotion information for one novel, and the detail information area displayed below the top area shows a plurality of novels that can be selected under the page in a form of a list.

For the top information area shown on the target page, the current display state may be specifically determined, so as to determine a display process when the current display state changes to a target state according to the target state determined by the sliding operation of the user in the subsequent display process.

The current display state may specifically include an initial state, a contracted state, or an expanded state. Here, the initial state is the display state of the top information area when the user opens the target page, that is, the display state of the top information area when the user does not perform the sliding operation on the target page. The contracted state means that the target page is completely contracted, and the state of the top information area is not displayed in the target page. The expanded state refers to a state in which the top information area is fully expanded.

For the initial state and the expanded state described above, since the state of the top information area is displayed on the target page, a boundary location of the top information area may be determined for ease of distinguishing the two cases. Specifically, when the top information area is displayed on the target page, one side of the top information area is displayed on the ceiling, and thus the other side of the ceiling side is selected as the boundary location. For the top information area in the initial state, the area selected by the boundary location and the top frame of the target page may be specifically smaller than the area selected from the boundary location corresponding to the expanded state and the top frame of the target page.

In an example, reference is made to FIG. 3, which is a schematic diagram of the top information area under different display states according to embodiments of the present disclosure. In FIG. 3, (a) is a schematic diagram of the top information area in the initial state, (b) is a schematic diagram of the top information area in the expanded state, and (c) is a schematic diagram of the top information area in the contracted state. The boundary location of the top information area is shown in FIG. 3 (a) and (b), since the boundary location in the initial state is closer to the top of the target page than the boundary location in the expanded state, the top information area in the initial state is smaller than the area of page occupied by the top information area in the expanded state. In FIG. 3 (c), in the contracted state, the boundary location of the top information area is overlapped with the top of the target page, so the top information area is not displayed.

In addition, for the detail information area associated with the top information area, the top of the detail information area overlapped with or is close to the boundary of the top information area. The opposite side, that is, the bottom of the detail information area, is overlapped with or adjacent to the bottom of the target page, for example, fixed to the bottom of the graphic display interface.

In some embodiments, in different cases, it may be determined that the current display state of the top information area is the three different states. Specifically, in response to the trigger operation for opening the target page, in a time period in which the target page is initially presented to the user, and the user still does not perform the sliding trigger operation on the target page, it may be determined that the current display state of the top information area on the target page is the initial state. When the top information area is selected to be completely displayed or hidden in response to the sliding operation by the user, the current display state of the top information area may be determined to be the expanded state or the contracted state. Here, the specific approach of changing the display state of the top information area according to the sliding operation by the user may refer to the following description, and details are not described herein again.

For the foregoing S102, after the target page is displayed to the user, the user may determine, according to the actual information obtaining requirement, whether to contract or expand the top information area, so that the detail information area or the top information area occupies a larger area on the target page for display, thereby obtaining information more easily.

Specifically, according to the sliding operation by the user on the target page and the current display state of the top information area determined in the above step, the operation intention of the user may be analyzed to determine the target state of the top information area under the sliding operation by the user, that is, the actual display requirement of the user on the top information area.

In a specific implementation, since the current display state of the top information area is specifically referenced when the target state is determined, the corresponding determined target state varies depending on the current display state. The following separately describes different situations of the current display state:

(a) When the current display state is an initial state, the target state of the top information area is determined.

In this case, in response to the sliding operation being indicative of displaying the top information area, it is determined that the target state of the top information area is the expanded state; or, in response to the sliding operation being indicative of contracting the top information area, it is determined that the target state of the top information area is the contracted state.

The sliding operation may specifically be a corresponding operation under the sliding behavior when the user touches the graphical user interface displaying the target page. Here, the sliding behavior may be determined as a up sliding operation or a down sliding operation, and the specific sliding operation under the sliding behavior may be determined by a sliding component.

In a possible case, for the top information area, because the top information area is displayed at the top of the target page, when the sliding operation indicates that the sliding behavior of the user is sliding downward, it may be considered that the display requirement for the top information area expressed by the sliding behavior of the user is to expand and display the top information area, or even if the top information area occupies a larger area in the target page, correspondingly, the target state of the top information area is determined to be the expanded state.

Similarly, when the sliding operation indicates that the sliding behavior of the user is sliding upward, it may be considered that the display requirement for the top information area expressed by the sliding behavior of the user is to contract the top information area, and in a possible display state of the top information area, that is, the top information area is hidden, the target state of the top information area is correspondingly determined to be the contracted state.

(b) When the current display state includes the contracted state or the expanded state, the target state of the top information area is determined.

In this case, in response to the current display state being the contracted state and the sliding being indicative of expanding the top information area, or in response to the current display state being the expanded state and the sliding being indicative of contracting the top information area, a sliding parameter corresponding to the sliding operation is determined, so as to determine the target state of the top information area using the sliding parameter.

Here, when the viewing intention of the user on the top information area is determined by using the sliding operation, since the sliding operation by the user may only be a small amplitude sliding operation on the target page, the expressed viewing intention is not to change the display form of the top information area; or, it may also be a relatively large sliding operation, and the expressed viewing intention is to change the display form of the top information area. Therefore, different from the case in (a), in this case, it is also necessary to more accurately analyze the sliding operation to determine the actual intention corresponding to the sliding operation by the user, so as to determine the target state of the top information area.

Specifically, the sliding parameter includes at least one of a sliding distance and a sliding speed. In a possible case, the sliding parameter corresponding to the sliding operation may be determined according to the actual typesetting direction of the information on the target page. For example, on the target page shown in FIG. 2, the information is typeset from top to bottom, and thus when viewing information, the user may read along the vertical direction of the target page. Therefore, when the sliding parameter is determined, the sliding distance and the sliding speed of the sliding operation in the vertical direction may be specifically determined. In an actual application, a sliding operation monitoring control in the platform may also be directly invoked to obtain the sliding parameter, which may be determined according to actual conditions and is not limited here.

In a case where the sliding parameter is determined, when the target state of the top information area is determined by using the sliding parameter, the following approaches may be specifically used: in response to the sliding speed in the sliding parameter being greater than a predetermined threshold, determining that the target state is the contracted state or the expanded state different from the current display state; and in response to the sliding speed in the sliding parameter being less than the predetermined threshold, determining whether the sliding is indicative of crossing a predetermined decision line based on the sliding distance in the sliding parameter, and determining the target state based on a determining result; wherein a location of the predetermined decision line on the target page is determined based on a boundary location of the top information area in the contracted state or the expanded state.

In a possible case, if the sliding speed in the sliding parameter is relatively large, for example, the sliding action is a short-distance fast sliding action, the operation intention of the user may be considered as changing the current display state, for example, the state corresponding to the top information area in the contracted state is converted into the expanded state, or the state corresponding to the top information area in the expanded state is converted into the contracted state. Therefore, in a case where the sliding speed is relatively large, it may be considered that according to the sliding operation of the user, the top information area may be contracted or expanded with “inertia” according to the sliding operation of the user, that is, the target state may be directly determined to be the contracted state or the expanded state different from the current display state.

Here, a predetermined threshold may be set when determining whether the sliding speed may reach a larger judgment condition. Since the operation time of the sliding operation is generally short, the number of pixels slid in the vertical direction of the target page by the sliding operation in one millisecond may be determined in milliseconds as the sliding speed, which is compared with the predetermined threshold to determine whether the judgment condition of sliding speed greater than the predetermined threshold is met.

In another possible case, if the sliding speed and the predetermined threshold are used to determine that the current sliding operation does not reach a large sliding speed, for example, the sliding action is a slow sliding motion that continuously touches the graphical display interface, the target state needs to be determined according to the sliding distance.

Specifically, it may be determined that the current display state of the top information area is changed by setting a predetermined decision line, and the judgment mechanism of the predetermined decision line described herein is that the sliding operation crosses the predetermined decision line; and if the sliding operation does not cross the predetermined decision line, it is determined to maintain the current display state of the top information area.

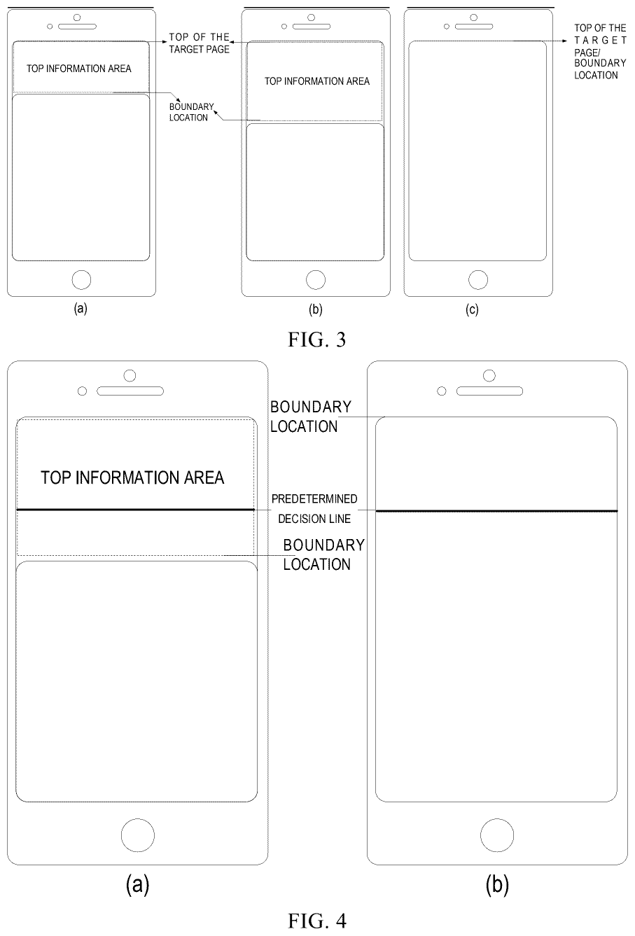

The position of the predetermined decision line on the target page is determined based on the boundary location of the top information area in the contracted state or the expanded state. For example, reference is made to FIG. 4 which is a schematic diagram of a predetermined decision line according to embodiments of the present disclosure. In FIG. 4, (a) is the top information area in the expanded state, (b) in FIG. 4 is the top information area in the contracted state, and the boundary locations corresponding to the top information areas in the two different states are respectively labeled in the corresponding drawings. The predetermined decision line is, for example, between the boundary location of the top information area in the expanded state and the boundary location of the top information area in the contracted state.

In a possible case, whether the sliding operation crosses the decision line may be directly determined, for example, based on whether the user's sliding operation has a factual behavior of crossing the decision line on the target page, it is directly determined whether the sliding operation itself is the operation of crossing the predetermined decision line. Generally, in this case, the user usually operates by dragging the boundary location of the top information area.

In another possible case, when determining whether the sliding is indicative of crossing the predetermined decision line based on the sliding distance, the distance between the top of the target page and the predetermined decision line may be determined first, and if the sliding distance is greater than the distance, it is considered that the sliding operation indicates that the predetermined decision line is crossed, otherwise, it is considered that the operation indicates that the predetermined decision line is not crossed. Generally, if the user wants to change the display state of the top information area, the user may directly trigger the sliding operation in the top information area, so the sliding operation may not necessarily cross the decision line in position. The approach of determining whether to indicate crossing the predetermined decision line by sliding distance may solve the problem of not being able to change the state of the top information area based on the user's true intention in the above situation.

In some embodiments, when determining whether the sliding is indicative of crossing the predetermined decision line based on the sliding distance in the sliding parameter, the following approaches may be specifically used: determining a sliding variation distance of the boundary location of the top information area by using the sliding distance; determining whether the sliding variation distance is greater than a separation distance between the boundary location of the top information area in the current display state and a boundary location of the predetermined decision line; and in response to the sliding variation distance being less than the separation distance, determining that the sliding is indicative of non-crossing the predetermined decision line, otherwise, determining that the sliding is indicative of crossing the predetermined decision line.

In this way, the judgment result of whether the sliding operation indicates crossing the preset judgment line can be obtained. When the target state is determined by using the judgment result, the following approaches may be specifically used: in response to the determining result being that the sliding is indicative of non-crossing the predetermined decision line, determining that the target state is the current display state; or in response to the determining result being that the sliding is indicative of crossing the predetermined decision line, determining that the target state is the contracted state or the expanded state different from the current display state.

That is, by using the sliding speed and/or the sliding distance in the sliding parameter to determine whether the sliding operation indicates the crossing of the predetermined decision line, the target state may be determined with relatively simple and definite logic. Specifically, if the interactive operation indicates that the predetermined decision line is not crossed, it is determined that the target state does not change, and the current display state is maintained; if the interactive operation indicates the predetermined decision line is crossed, it is determined to change the target state a contracted state or an expanded state different from the current display state.

In addition to the two cases of (a) and (b), there may be the following two cases. The current display state is a contracted state and the sliding operation indicates to contract the top information area. Further, the current display state is an expanded state, and the sliding operation indicates to expand the top information area. Both cases may specifically occur in the case of user misoperation, since the sliding operation indicates that the target state of changing the top information area is the same as the current display state, the selection does not change the state of the top information area.

In this way, the target state may be determined for the top information area according to the actual sliding operation and the determined current display state.

For the above S103, when the current display state and the target state of the top information area are determined according to the above steps, the display state of the top information area may be updated to the target state. In order to make the change of the display state more smooth, in embodiments of the present disclosure, the changed effect of the top information area displayed in the sliding operation is selected and updated, that is, the complete change process of the top information area changed from the current display state to the target state is displayed to the user, so that the top information area gradually changes to the target state.

Correspondingly, when the top information area changes, that is, the boundary location of the top information area changes up and down on the target page and there is also a detailed information area associated with display location below the top information area. In order to reflect the change process of the top information area, the detail information area also follows the change, specifically, the top of the detail information area moves up and down along with the boundary location of the top information area, the area occupied by the detail information area expands or reduces on the target page due to the change of the top, and the included information is correspondingly expanded or partially hidden. In this way, the process of expanding and reducing the detail information area may also reflect the change process of the top information area.

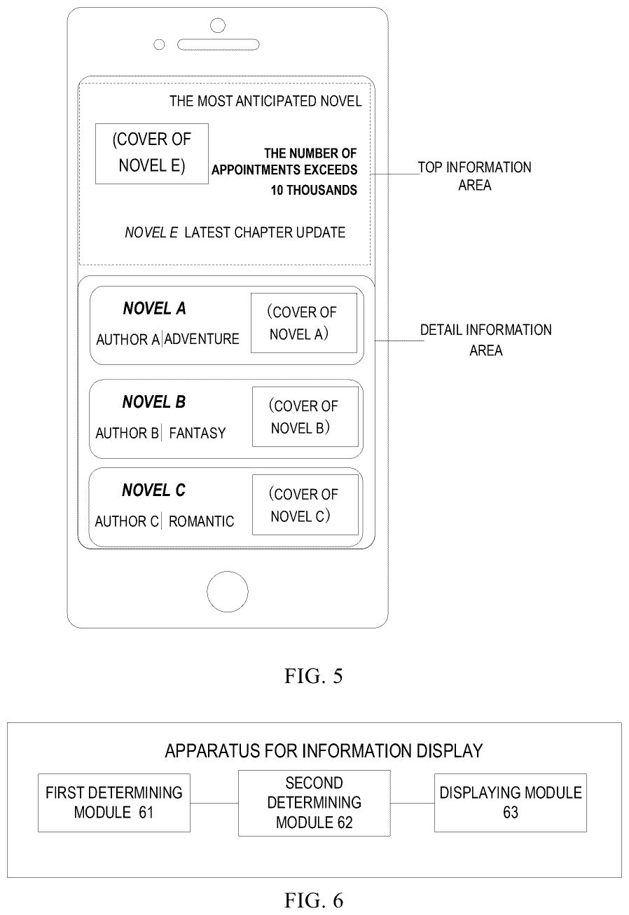

For example, if the initial state of the top information area in the page shown in FIG. 2 is used as the current display state, as shown in FIG. 5, it is a schematic diagram of changing the top information area to the expanded state according to embodiments of the present disclosure. Compared to FIG. 2, the top information area shown in FIG. 5 becomes larger. In a process of changing the size of the area occupied by the top information area, a custom animation may also be set, or a customized sliding animation may be implemented by setting a change parameter. The information in the top information area may also be stretched or the layout can be changed accordingly, and the content can be added or subtracted according to the changes in the area. The specific details can be determined according to the actual situation, and will not be repeated here.

Correspondingly, since the top information area becomes larger, the detail information area correspondingly becomes smaller due to the limitation of the graphic display interface. Specifically, the information displayed may change, for example, the information content related to novel D shown in FIG. 2 is not shown in FIG. 5.

For the display method described above, in a specific implementation, the top information area and the detail information area may be specifically configured by using a nested scrolling structure Coordinator Layout, and a state change action of the top information area and/or the detail information is carried by the AppBarLayout component. In the process of changing the display state of the top information area, the user may also stop changing the state at any time. For example, the trigger operation on the page may be stopped.

In another embodiment of the present disclosure, since more information may be specifically included in the detail information area, for example, a plurality of pieces of information in a list is shown in FIG. 2 and FIG. 5, and the user may view the information not displayed in the list by sliding up and down the detail information area. In order to be able to decide whether the operation intention of the user is the indication of displaying the information in the detail information area, the content displayed in the detail information area may be updated according to the sliding operation of the user when it is determined that the current display state of the top information area is the contracted state and the sliding operation indicates to display detail information area, that is, only the detail information area is displayed on the target page.

In some specific implementations, the displaying of the detail information area may be updated based on a sliding parameter corresponding to the sliding. The sliding parameter herein may also include the sliding speed, and the sliding distance described above. For example, taking the sliding operation indicating to scroll up the information in the detail information area to view more information as an example, if the sliding speed is large, it may be considered that more information may continue to be displayed according to inertia. If the sliding speed is small, it may be determined according to the sliding distance that the information in the detail information area should continue to display the pixel height in the vertical direction, and the information in the area corresponding to the pixel height may be update. Specifically, it may also be determined according to actual conditions, and details are not described herein again.

Those skilled in the art may understand that, in the above method of the specific embodiments, the writing order of each step does not imply a strict execution order and constitutes any limitation on the implementation process, and the specific execution sequence of each step should be determined in its function and possible internal logic.

Based on the same inventive concept, in embodiments of the present disclosure, an apparatus for information display corresponding to the method for information display is further provided.

Reference is made to FIG. 6, which is a schematic diagram of an apparatus for information display according to embodiments of the present disclosure. The apparatus includes: a first determining module 61, a second determining module 62, and a displaying module 63, where,

The first determining module 61 is configured to determine a current display state of a top information area displayed on a target page.

The second determining module 62 is configured to, in response to sliding on the target page, determine a target state of the top information area based on the sliding and the current display state.

The displaying module 63 is configured to update to display a changed effect of the top information area under the sliding, to cause the top information area to change from the current display state to the target state, and display a detail information area on the target page based on the changed effect; the detail information area being associated with a display location of the top information area on the target page.

In an optional implementation, the current display state comprises a contracted state or an expanded state, and when determining the target state of the top information area based on the sliding and the current display state, the second determining module 62 is configured to: in response to the current display state being the contracted state and the sliding being indicative of expanding the top information area, or in response to the current display state being the expanded state and the sliding being indicative of contracting the top information area, determine a sliding parameter corresponding to the sliding to determine the target state of the top information area using the sliding parameter.

In an optional implementation, the sliding parameter comprises at least one of a sliding distance or a sliding speed; when determining the target state of the top information area based on the sliding parameter, the second determining module 62 is configured to: in response to the sliding speed in the sliding parameter being greater than a predetermined threshold, determine that the target state is the contracted state or the expanded state different from the current display state; and in response to the sliding speed in the sliding parameter being less than the predetermined threshold, determine whether the sliding is indicative of crossing a predetermined decision line based on the sliding distance in the sliding parameter, and determine the target state based on a determining result; wherein a location of the predetermined decision line on the target page is determined based on a boundary location of the top information area in the contracted state or the expanded state.

In an optional implementation, when determining whether the sliding is indicative of crossing the predetermined decision line based on the sliding distance in the sliding parameter, the second determining module 62 is configured to: determine a sliding variation distance of the boundary location of the top information area by using the sliding distance; determine whether the sliding variation distance is greater than a separation distance between the boundary location of the top information area in the current display state and a boundary location of the predetermined decision line; and in response to the sliding variation distance being less than the separation distance, determine that the sliding is indicative of non-crossing the predetermined decision line, otherwise, determining that the sliding is indicative of crossing the predetermined decision line.

In an optional implementation, when determining the target state based on the determining result, the second determining module 62 is configured to: in response to the determining result being that the sliding is indicative of non-crossing the predetermined decision line, determine that the target state is the current display state; or in response to the determining result being that the sliding is indicative of non-crossing the predetermined decision line, determine that the target state is the contracted state or the expanded state different from the current display state.

In an optional implementation, the current display state comprises an initial state; when determining the target state of the top information area based on the sliding and the current display state, the second determining module 62 is configured to: in response to the sliding being indicative of displaying the top information area, determine that the target state of the top information area is an expanded state; or in response to the sliding being indicative of contracting the top information area, determine that the target state of the top information area is a contracted state.

In an optional implementation, the display module 63 is further configured to: in response to the current display state of the top information area being a contracted state, and the sliding being indicative of displaying the detail information area, update the displaying of the detail information area based on a sliding parameter corresponding to the sliding.

For the process flow of each module in the apparatus and the description of the interaction flow between the modules, the related description in the foregoing method embodiments may be referred to, and details are not described herein again.

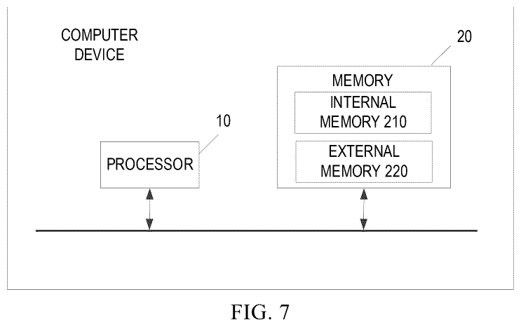

Embodiments of the present disclosure further provides a computer device, as shown in FIG. 7, which is a schematic structural diagram of a computer device according to embodiments of the present disclosure, including:
a processor 10 and a memory 20, where the memory 20 stores machine-readable instructions executable by the processor 10, the processor 10 is configured to execute the machine-readable instructions stored in the memory 20, and the processor 10, when the machine-readable instructions are executed by the processor 10, performs the following steps:

The memory 20 stores machine readable instructions executable by the processor 10, the processor 10 is configured to execute the machine readable instructions stored in the memory 20, and when the machine readable instructions are executed by the processor 10, the processor 10 performs the following steps:
determining a current display state of a top information area displayed on a target page; in response to sliding on the target page, determining a target state of the top information area based on the sliding and the current display state; and updating to display a changed effect of the top information area under the sliding, to cause the top information area to change from the current display state to the target state, and displaying a detail information area on the target page based on the changed effect; the detail information area being associated with a display location of the top information area on the target page.

The memory 20 includes an internal memory 210 and an external memory 220. The internal memory 210 herein is also referred to as an internal storage for temporarily storing operational data in the processor 10, and data exchanged with an external memory 220 such as a hard disk, and the processor 10 exchanges data with the external memory 220 through the internal memory 210.

The specific execution process of the above instructions may refer to the steps of the method for information display described in embodiments of the present disclosure, which will not be repeated here.

Embodiments of the present disclosure further provides a computer-readable storage medium, where the computer-readable storage medium stores a computer program that, when executed by a computer device, performs the steps of the method for information display described in the foregoing method embodiments. The storage medium may be a volatile or non-volatile computer readable storage medium.

Embodiments of the present disclosure further provides a computer program product, where the computer program product carries program code, and the program code includes instructions that may be used to perform the steps of the method for information display described in the foregoing method embodiments.

The computer program product may be specifically implemented by hardware, software, or a combination thereof. In an optional embodiment, the computer program product is embodied as a computer storage medium, and in another optional embodiment, the computer program product is embodied as a software product, for example, a software development kit (SDK).

Those skilled in the art can clearly understand that, for the convenience and conciseness of description, the specific working process of the system and apparatus described above may refer to the corresponding process in the foregoing method embodiments and will not be repeated here. In the several embodiments provided by the present disclosure, it should be understood that the disclosed system, apparatus and method may be implemented by other means. The apparatus embodiments described above are only schematic. For example, the partitioning of the units is only a logical function partitioning. There may be other partitioning modes during actual implementation. For another example, a plurality of units or components can be combined or integrated into another system, or some features can be ignored or not executed. In addition, the coupling or direct coupling or communication connection that is shown or discussed may be an indirect coupling or communication connection through some communication interfaces, apparatuses or units, and may be electrical, mechanical or other forms.

The units described as separate components may or may not be physically separated, and the components presented as units may or may not be physical units, that is, may be located in one place, or may be distributed to multiple network units. Some or all of the units can be selected according to the actual needs to achieve the objects of the solutions of the embodiments.

In addition, the functional units in various embodiments of the present disclosure may be integrated in a single processing unit. Or, the units may exist physically separately, or two or more units may be integrated in a single unit.

The functions, if implemented in the form of a software functional unit and sold or used as a stand-alone product, may be stored in a non-volatile computer readable storage medium that may be executed by a processor. Based on this understanding, the technical solution of the present disclosure in essence (or parts that contribute to the prior art or parts of this technical solution) may be embodied in the form of a software product. This computer software product is stored in a storage medium and includes a plurality of instructions for causing a computer device (which may be a personal computer, server, or network device, etc.) to perform all or part of the steps of the method described in various embodiments of the present disclosure. The aforementioned storage media includes: a U disk, a portable hard disk, a read-only memory (ROM), a random access memory (RAM), a magnetic disk or an optical disc and other media that can store program codes therein.

Finally, it should be noted that the above embodiments are only specific implementations of the present disclosure, which are used to illustrate the technical solutions of the present disclosure, and are not intended to limit the technical solution of the present disclosure. Therefore, the protection scope of the present disclosure is not limited to this. Although the detailed description is made to the present disclosure by reference to the foregoing embodiments, those of ordinary skills in the art shall understand that, within the technical scope disclosed herein, any skilled person who is familiar with the technical field can still modify or easily think of changes to the technical solution recorded in the foregoing embodiments, or make equivalent replacements for some of the technical features. Such modifications, changes or replacements shall not make the essence of the corresponding technical solutions depart from the spirit and scope of the technical solutions of the various embodiments of the present discourse, and shall be covered by the protection scope of the present disclosure. Therefore, the protection scope of the present disclosure should be subject to the appended claims.

1. A method for information display, comprising:
determining a current display state of a top information area displayed on a target page;
in response to sliding on the target page, determining a target state of the top information area based on the sliding and the current display state; and
updating to display a changed effect of the top information area under the sliding, to cause the top information area to change from the current display state to the target state, and displaying a detail information area on the target page based on the changed effect; the detail information area being associated with a display location of the top information area on the target page.

2. The method of claim 1, wherein the current display state comprises a contracted state or an expanded state; and determining the target state of the top information area based on the sliding and the current display state comprises:
in response to the current display state being the contracted state and the sliding being indicative of expanding the top information area, or in response to the current display state being the expanded state and the sliding being indicative of contracting the top information area, determining a sliding parameter corresponding to the sliding to determine the target state of the top information area using the sliding parameter.

3. The method of claim 2, wherein the sliding parameter comprises at least one of a sliding distance or a sliding speed;
determining the target state of the top information area based on the sliding parameter, comprising:
in response to the sliding speed in the sliding parameter being greater than a predetermined threshold, determining that the target state is the contracted state or the expanded state different from the current display state; and
in response to the sliding speed in the sliding parameter being less than the predetermined threshold, determining whether the sliding is indicative of crossing a predetermined decision line based on the sliding distance in the sliding parameter, and determining the target state based on a determining result; wherein a location of the predetermined decision line on the target page is determined based on a boundary location of the top information area in the contracted state or the expanded state.

4. The method of claim 3, wherein determining whether the sliding is indicative of crossing the predetermined decision line based on the sliding distance in the sliding parameter comprises:
determining a sliding variation distance of the boundary location of the top information area by using the sliding distance;
determining whether the sliding variation distance is greater than a separation distance between the boundary location of the top information area in the current display state and a boundary location of the predetermined decision line; and
in response to the sliding variation distance being less than the separation distance, determining that the sliding is indicative of non-crossing the predetermined decision line, otherwise, determining that the sliding is indicative of crossing the predetermined decision line.

5. The method of claim 3, wherein determining the target state based on the determining result comprises:
in response to the determining result being that the sliding is indicative of non-crossing the predetermined decision line, determining that the target state is the current display state; or
in response to the determining result being that the sliding is indicative of crossing the predetermined decision line, determining that the target state is the contracted state or the expanded state different from the current display state.

6. The method of claim 1, wherein the current display state comprises an initial state; and determining the target state of the top information area based on the sliding and the current display state comprises:
in response to the sliding being indicative of displaying the top information area, determining that the target state of the top information area is an expanded state; or
in response to the sliding being indicative of contracting the top information area, determining that the target state of the top information area is a contracted state.

7. The method of claim 1, further comprising:
in response to the current display state of the top information area being a contracted state, and the sliding being indicative of displaying the detail information area, updating the displaying of the detail information area based on a sliding parameter corresponding to the sliding.

8. (canceled)

9. A computer device, comprising: a processor and a memory, wherein the memory stores machine-readable instructions executable by the processor, the processor is configured to execute the machine-readable instructions stored in the memory, and the processor, when the machine-readable instructions are executed by the processor, performs operations comprising:
determining a current display state of a top information area displayed on a target page;
in response to sliding on the target page, determining a target state of the top information area based on the sliding and the current display state; and
updating to display a changed effect of the top information area under the sliding, to cause the top information area to change from the current display state to the target state, and displaying a detail information area on the target page based on the changed effect; the detail information area being associated with a display location of the top information area on the target page.

10. A non-transitory computer-readable storage medium, wherein the computer-readable storage medium stores a computer program that, when executed by a computer device, performs operations comprising:
determining a current display state of a top information area displayed on a target page;
in response to sliding on the target page, determining a target state of the top information area based on the sliding and the current display state; and
updating to display a changed effect of the top information area under the sliding, to cause the top information area to change from the current display state to the target state, and displaying a detail information area on the target page based on the changed effect; the detail information area being associated with a display location of the top information area on the target page.

11. The device of claim 8, wherein the current display state comprises a contracted state or an expanded state; and determining the target state of the top information area based on the sliding and the current display state comprises:
in response to the current display state being the contracted state and the sliding being indicative of expanding the top information area, or in response to the current display state being the expanded state and the sliding being indicative of contracting the top information area, determining a sliding parameter corresponding to the sliding to determine the target state of the top information area using the sliding parameter.

12. The device of claim 9, wherein the sliding parameter comprises at least one of a sliding distance or a sliding speed;
determining the target state of the top information area based on the sliding parameter, comprising:
in response to the sliding speed in the sliding parameter being greater than a predetermined threshold, determining that the target state is the contracted state or the expanded state different from the current display state; and
in response to the sliding speed in the sliding parameter being less than the predetermined threshold, determining whether the sliding is indicative of crossing a predetermined decision line based on the sliding distance in the sliding parameter, and determining the target state based on a determining result; wherein a location of the predetermined decision line on the target page is determined based on a boundary location of the top information area in the contracted state or the expanded state.

13. The device of claim 10, wherein determining whether the sliding is indicative of crossing the predetermined decision line based on the sliding distance in the sliding parameter comprises:
determining a sliding variation distance of the boundary location of the top information area by using the sliding distance;
determining whether the sliding variation distance is greater than a separation distance between the boundary location of the top information area in the current display state and a boundary location of the predetermined decision line; and
in response to the sliding variation distance being less than the separation distance, determining that the sliding is indicative of non-crossing the predetermined decision line, otherwise, determining that the sliding is indicative of crossing the predetermined decision line.

14. The device of claim 10, wherein determining the target state based on the determining result comprises:
in response to the determining result being that the sliding is indicative of non-crossing the predetermined decision line, determining that the target state is the current display state; or
in response to the determining result being that the sliding is indicative of crossing the predetermined decision line, determining that the target state is the contracted state or the expanded state different from the current display state.

15. The device of claim 8, wherein the current display state comprises an initial state; and determining the target state of the top information area based on the sliding and the current display state comprises:
in response to the sliding being indicative of displaying the top information area, determining that the target state of the top information area is an expanded state; or
in response to the sliding being indicative of contracting the top information area, determining that the target state of the top information area is a contracted state.

16. The device of claim 8, the operations further comprising:
in response to the current display state of the top information area being a contracted state, and the sliding being indicative of displaying the detail information area, updating the displaying of the detail information area based on a sliding parameter corresponding to the sliding.

17. The medium of claim 15, wherein the current display state comprises a contracted state or an expanded state; and determining the target state of the top information area based on the sliding and the current display state comprises:
in response to the current display state being the contracted state and the sliding being indicative of expanding the top information area, or in response to the current display state being the expanded state and the sliding being indicative of contracting the top information area, determining a sliding parameter corresponding to the sliding to determine the target state of the top information area using the sliding parameter.

18. The medium of claim 16, wherein the sliding parameter comprises at least one of a sliding distance or a sliding speed;
determining the target state of the top information area based on the sliding parameter, comprising:
in response to the sliding speed in the sliding parameter being greater than a predetermined threshold, determining that the target state is the contracted state or the expanded state different from the current display state; and
in response to the sliding speed in the sliding parameter being less than the predetermined threshold, determining whether the sliding is indicative of crossing a predetermined decision line based on the sliding distance in the sliding parameter, and determining the target state based on a determining result; wherein a location of the predetermined decision line on the target page is determined based on a boundary location of the top information area in the contracted state or the expanded state.

19. The medium of claim 17, wherein determining whether the sliding is indicative of crossing the predetermined decision line based on the sliding distance in the sliding parameter comprises:
determining a sliding variation distance of the boundary location of the top information area by using the sliding distance;
determining whether the sliding variation distance is greater than a separation distance between the boundary location of the top information area in the current display state and a boundary location of the predetermined decision line; and
in response to the sliding variation distance being less than the separation distance, determining that the sliding is indicative of non-crossing the predetermined decision line, otherwise, determining that the sliding is indicative of crossing the predetermined decision line.

20. The medium of claim 17, wherein determining the target state based on the determining result comprises:
in response to the determining result being that the sliding is indicative of non-crossing the predetermined decision line, determining that the target state is the current display state; or
in response to the determining result being that the sliding is indicative of crossing the predetermined decision line, determining that the target state is the contracted state or the expanded state different from the current display state.

21. The medium of claim 15, wherein the current display state comprises an initial state; and determining the target state of the top information area based on the sliding and the current display state comprises:
in response to the sliding being indicative of displaying the top information area, determining that the target state of the top information area is an expanded state; or
in response to the sliding being indicative of contracting the top information area, determining that the target state of the top information area is a contracted state.
